(19) United States
(12) Patent Application Publication
(10) Pub. No.: US 2025/0255324 A1
(43) Pub. Date: Aug. 14, 2025

(54) METHOD FOR INCREASING NUTRITION VALUE OF ANIMAL FORAGE

(71) Applicant: Edwin A. NEAL, Phoenix, AZ (US)

(72) Inventor: Edwin A. NEAL, Phoenix, AZ (US)

(21) Appl. No.: 18/438,044

(22) Filed: Feb. 9, 2024

Related U.S. Application Data
(63) Continuation-in-part of application No. 18/321,676, filed on May 22, 2023, now abandoned.
(60) Provisional application No. 63/615,026, filed on Dec. 27, 2023.

(51) Int. Cl. A23K 10/30; A23K 20/20

(52) U.S. Cl. CPC A23K 10/30; A23K 20/20

(57) ABSTRACT

A method for increasing the nutritional value of forage used for animal feed includes exposing the forage to a vapor of methytrichlorosilane MTS in a heated environment, the MTS reacts with water moisture in the forage to form hydrochloric acid and then introducing a vapor of anhydrous ammonia which reacts with the hydrochloric acid to form and diffusely distribute ammonia chloride through material.

### CLAIM OF PRIORITY

The present application includes subject matter disclosed in and claims priority to provisional patent application entitled “Method For Increasing Nutrition Value Of Animal Forage” filed Dec. 27, 2023 and assigned Ser. No. 63/615,026, describing inventions made by the present inventor, and both herein incorporated by reference.

### BACKGROUND OF THE INVENTION

### 1. Field of the Invention

The present disclosure relates to a method for increasing the nutritional value of forage used for animal feed. In particular, the present disclosure relates to a method of adding ammonium chloride to bagasse and other animal forages to increase its nutritional value.

### 2. Description of Related Art

The U.S. sugar cane industry is located in the tropical and subtropical regions of Florida, Texas, Louisiana, Hawaii, and Puerto Rico. Except for Hawaii, where sugar cane production takes place year-round, sugar mills operate seasonally from two to five months per year.

Sugar cane is a large grass with a bamboo-like stalk that grows 8 to 15 feet tall. Only the stalk contains sufficient sucrose for processing into sugar. All other parts of the sugar cane (i.e., leaves, top growth, and roots) are termed “trash”. The objective of harvesting is to deliver the sugar cane to the mill with a minimum of trash or other extraneous material. The cane is normally burned in the field to remove a major portion of the trash and to control insects and rodents. The three most common methods of harvesting are hand cutting, machine cutting, and mechanical raking. The cane that is delivered to a particular sugar mill will vary in trash and dirt content depending on the harvesting method and weather conditions. Inside the mill, cane preparation for extraction usually involves washing the cane to remove trash and dirt, chopping, and then crushing. Juice is extracted in the milling portion of the plant by passing the chopped and crushed cane through a series of grooved rolls. The cane remaining after milling is bagasse.

Bagasse is the matted cellulose fiber residue from sugar cane that has been processed in a sugar mill. Sugar cane bagasse (SCB) is an abundant byproduct of the sugar and ethanol industry. SCB is generally used as a fertilizer or is disposed of in landfills, which has led to intensified environmental concerns. Sugarcane (Saccharum officinarum) bagasse (SCB) is a biomass of agricultural waste obtained from sugarcane processing that has been found in abundance globally. Due to its abundance in nature, researchers have been harnessing this biomass for numerous applications such as in energy and environmental sustainability.

Bagasse has been used by the sugar industry as a fuel source. Plantations, where irrigation requirements are minor, have always had an excess supply of bagasse. Since 1969, in response to EPA requirements, numerous plantations have enlarged their boiler capacity as a means of bagasse disposal. Bagasse as a by-product of sugar industry is the heterogeneous fibrous residue that remains after sugarcane stalks are crushed for sugar extraction. Dry bagasse consists of approximately 45% cellulose, 28% hemicellulose, 20% lignin, 5% sugar, 1% minerals, and 2% ash. Bagasse is similar in component to wood except that it has high moisture content. Thus, it is currently used as a biofuel and in the manufacture of pulp and paper products, filler for building materials and as a substrate for growing mushrooms. Considering the fact that much more bagasse is available than utilized for energy production, further value creation might be possible. Previously, bagasse was burned as a means of solid waste disposal.

It is therefore a primary object of the present invention to provide a method and system for achieving recovery and recycling of the bagasse.

It is a further object of the present invention to improve or transform biomass for agricultural feed.

These and other objects of the present invention will become apparent to those skilled in the art as the description thereof proceeds.

### SUMMARY OF THE INVENTION

The present invention is directed to a system for the treatment or enhancement of an organic compound, such as bagasse, by exposure to gaseous material, preferably a silane. The organic compound is exposed to gaseous material. Preferably the gas is MTS. The system may include an input hopper and a track to drive the bagasse material for treatment. Untreated bagasse enters a channel, preferably a trommel. The bagasse is preferably continually exercised/churned/tossed/agitated by internal flights or other mechanism to stir the mixture. The trommel is preferably a revolving cylindrical sieve, preferably with flights or other tossing/agitating systems. Preferably the trommel is only 10-20% full of bagasse. A source of the gas is applied early, soon after the entry of the bagasse and mixed with the tosses bagasse for treatment. Untreated bagasse enters the trommel, begins treatment, and is exited through an out on the far side. Bagasse is treated instantaneously through exposure to the gas. Treated bagasse, with a higher nitrogen component, is sent out of the trommel and into a storage bin or other catch.

The present invention also includes a method for the treatment or enhancement of an organic compound by exposure to gaseous material. The material is fed into a stage where it may be exposed to a gas, preferably MTS. The treated material exits the treatment stage and can be recovered as a treated material with enhanced attributes, such as higher nutrition, nitrogen, or ammonium, or amino acid content. Excess moisture may be removed from the organic material during the process, preferably by heating. The bagasse may be dried before exposure to the treatment gas. The drying may be set immediately before entry to the trommel, or may be a first stage within the trommel prior to exposure to gas. The gas may react with water vapor to activate or use as catalysis when contacting the bagasse. The treated organic material may be used directly or mixed with a filler, or further enhancement and used as animal forage (feed).

### BRIEF DESCRIPTION OF THE DRAWINGS

The present invention will be described with greater specificity and clarity with reference to the following drawings, in which:

FIG. 1 illustrates a cross-sectional side diagram of the treatment system and process of an embodiment of the present invention.

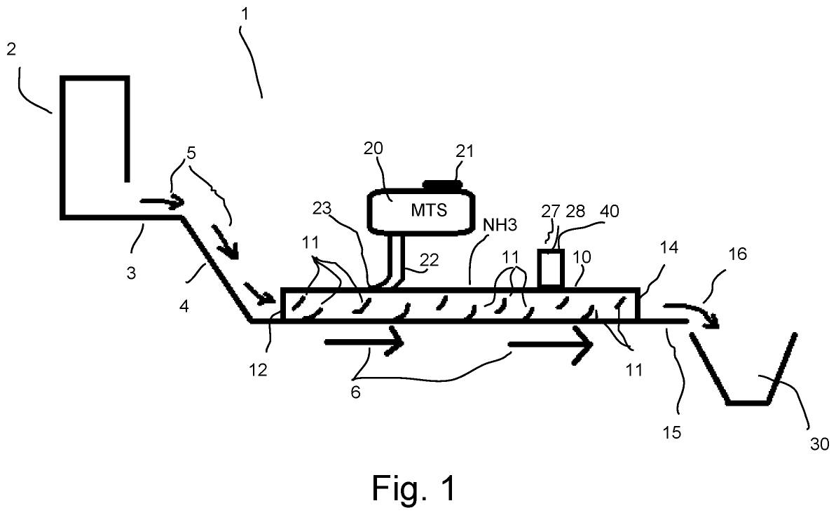

### DETAILED DESCRIPTION OF THE PREFERRED EMBODIMENTS

The present disclosure describes a method of increasing the nutritional value of forages commonly used as animal feed, and particularly animal feed for ruminants such as cattle. The method is applicable to any bulk forage that is commonly used as feed for animals, however the disclosure herein will describe the method as related to bagasse.

Bagasse as organic material useful in this invention may be sourced as dry pulpy fibrous material that remains after crushing sugarcane or sorghum stalks to extract their juice. It is used as a biofuel for the production of heat, energy, and electricity, and in the manufacture of pulp and building materials. Agave bagasse is similar, and useful, as remnant from extracting blue agave sap. Most any organic material including cellulose fibers may be useful in the present invention.

The method takes advantage of the reaction between silanes and water to form hydroxysilanes. Thus, the method to be effective requires the presence of some moisture in the forage. Too much moisture in the forage may, however, frustrate optimally efficient application of the method. Therefore, it may be desirable in some instances to dry the materials to lower the moisture content to between about 2% to about 40%.

According to one implementation of the invention, forage A having moisture content as mentioned is immersed in an inert gas that creates an environment in which the silane vapors can be safely introduced yet avoid volatility. Suitable inert gases include without limitation nitrogen, carbon monoxide, helium, carbon dioxide, argon, etc.

The forage is then heated to a first temperature of between about 180° F. and about 250 F and exposed to a vapor of methytrichlorosilane MTS until the MTS reacts with water moisture present in the materials to form hydrochloric acid HCL. In one implementation of the invention the first temperature range is between about 180 F and about 250° F. One particular advantage of the method is that HCL associates strongly with the water moisture which is diffusely present throughout the forage which results in the HCL also being diffusely distributed throughout the forage material.

After treatment with MTS, the forage is exposed to a vapor of anhydrous ammonia which penetrates the forage material and reacts with the HCL to create ammonium chloride. The result of the treatment is that ammonium chloride is produced in and diffusely distributed throughout the forage. Applicants have determined that the pH of the material after treatment is not significantly different than that of the untreated material. Residual HCl can be scrubbed using well understood technologies or it will evaporate naturally within a relatively short time.

The amount of ammonium chloride resident in the forage is directly proportional to the amount of MTS introduced to a volume of bagasse. Applicant has determined that 1 ml of MTS yields 3 ml of HCl assuming adequate moisture content in the forage. HCL in turn combines with an equal amount of anhydrous ammonia resulting in double the weight of ammonium chloride. For example, every 3 ml of HCL will combine with 3 ml of anhydrous ammonia to create 6 ml of ammonium chloride. Therefore, by controlling how much MTS the forage is exposed to, the amount of ammonium chloride in the forage can be controlled.

An advantage to the method is that the nutritional value of forage can be increased by preselected percentages. Accordingly, forages of different nutritional values can be made to feed specifications such as ten pe cent, twenty percent and thirty percent ammonia chloride as may be needed for different stages of development of livestock. As the bagasse is treated, the ammonium content in the bagasse increased and the nutritional content of the bagasse as useful for animal forage is increased. Thus, the refuse bagasse may be converted into a useful feed source.

Bagasse is fed into hopper or trowel or like conveyor. Bagasse is tumbled via paddles, and conveyor preferably includes an enclosed pathway. Bagasse fed into the initial end opening, preferably via gravity from a pile or truck. As bagasse travels down conveyor, it is tumbled. Shortly after the end, an entry provides access to input liquid silanes which quickly vaporize in pathway and is mixed in gaseous form with the tumbling organic material. As the product flows, the pressure in the system draws the gas along with the physically tumbled or moving organic material. After exposure for a few seconds, or up to one-minute, organic material as improved for animal feed exits the further rend. The amount of gas provided relative to the volume and mass of organic material impacts the percentage of ammonium in the final enhanced product.

Silanes useful in practicing the disclosed method include, without limitation:

Methyltrichlorosilane; (chloromethyl) trichlorosilane; 3-(heptafluoroisoproxy)propyl trichlorosilane 1,6-bis(trichlorosilyl)hexane; 3-bromopropyltrichlorosilane; allylbromodimethylsilane; allyltrichlorosilane; bromomethylchlorodimethylsilane; bromothimethylsilane; chloro(chloromethyl)dimethylsilane; chlorodiisopropyloctylsilane; chlorodiisopropylsilane; chlorodimethylethylsilane; chlorodimethylphenylsilane; chlorodimethylsilane; chlorodiphenylmethylsilane; chlorotriethylsilane; chlorotrimethylsilane; dichlorodimethylsilane; dichloromethylsilane; dichloromethylvinylsilane; diphenyldichlorosilane; di-t-butylchlorosilane; ethyltrichlorosilane; lodotrimethylsilane; pentyltrichlorosilane phenyltrichlorosilane; trichloro(3,3,3-trifluoropropyl)silane; trichloro(dichloromethyl)silane; and trichlorovinylsilane.

An important advantage of the method is that methyltrichlorosilane can be procured at low cost and is readily available whereas ammonium chloride is much more expensive. The method thus enables introduction of ammonium chloride in a forage at greatly reduced cost.

Types of forage materials that can benefit from the treatment described above include corn stalks, barley stalks, wheat stalks and other crop residues. It is generally understood that livestock can just maintain body condition with such crop residues but increasing the nutritional value of such secondary crop materials could provide a readily available and abundant source of nutrition for livestock.

A process flow diagram for the method is described herein. The bagasse may be moved on a feed roll, uptake roll, or conveyor belt, through a processing chamber where the forage is treated. In other instances, additional steps, treatments, or processes may occur before, after, or between what is described above. The treatment system 1 may introduce bagasse may be supplied in a container 2. Bagasse flows 5 on an optional platform 3, or bottom of container, along angled pathway 4 to an entry 12 of trommel 10. Any hollow tube or channel is useful for the trommel of the present invention, however, a cylindrical trommel with flights 11 is preferred. Trommel 10 may have flights 11 that are mounted onto internal walls of the trommel. As the trommel is rotated the flights serve to toss or agitate the solid bagasse material therein. Untreated bagasse enters entry 12. Soon thereafter, an inlet 23 for the gaseous material, such as MTS (preferably stored in liquid form in tank 20 (supplied through bung or sealed opening 21). Opening 21 may serve as a pressure-vacuum vent 27 or one-way valve vent to allow inflow of ambient air to fill volume as stored liquid/gas for treatment is drawn out. Gas/liquid for treatment may be forced at a set rate via a motor pump (not shown). The treatment fluid leaves the tank 20 through tube 22 to opening 23. As the liquid (or gas) falls on into the trommel 10, the liquid vapor pressure may cause the liquid to gasify/vaporize. Preferably, gravity is used to draw the treatment fluid into the trommel to expose to the bagasse. The vapors of the gas then may contact surface and surface area of agitated bagasse as the bagasse moves 6 through/in trommel 10. The gas reacts with the bagasse and form new compounds within the trommel. Bagasse leaves trommel 10 through exit way 14 with optional curtain on support 15, and bagasse flows 16 into a container. Bagasse may be moved with gravity, via an motorized conveyor, or other system known in the art.

For example, before entering the first chamber the cellulose material may be in a storage area or treatment area in which the forage material is dried or arrives at a moisture content level in a desired range such as 10-30% or 10-20%. By way of example, green or fresh wood chips freshly formed from lumber or wood may have a moisture content at or about 50% and will be dried or cured until the moisture content level is in a range of 10-30% or 10-20%.

Furthermore, after the treatment, the bagasse may be moved on to additional storage areas or bins, from which they may undergo subsequent processing such as adding molasses for improved taste, salts, or other additives.

The cellulose material may pass through the treatments described herein and be shown as the treatment apparatus of the system. The cellulose material may be collected on the conveyor, the cellulose material entering a first zone, area, or chamber 1 in which may be an inert zone comprised of first inert gas, such as nitrogen. The inert gas may be supplied to the first chamber by an inlet zone, nozzle, spigot, pe orated pipe or other ingress, as indicated by the upper arrow downwardly pointing to chamber 1. An egress or outlet from the first chamber by or through an outlet zone, nozzle, spigot, perforated pipe or other egress, as indicated by the lower arrow downwardly pointing from the chamber 1. The inlet gas, inlet zone and first vapor outlet zone may comprise one single chamber indicated as chamber 1, and alternatively may comprise or be subdivided into one or more separate chambers separated by a zone divider such as, for example, a curtain or soft baffle.

Alternative preferred embodiments of the present inventions include the introduction of anhydrous ammonia after introduction of MTS in the line. IN a long flight tube (line) with trommels, the bagasse is instantaneously exposed to MTS. Bagasse enters the line, with MTS added a few feet down the line after the liquid anhydrous ammonia. The MTS begins as a liquid and vaporizes in the heated line. The trommel preferably includes rotating flights and paddle to push the bagasse through as the line rotates. Bagasse may fill as much as ⅓ of the volume of the line. In prior embodiments, liquid forms and pentane produces a hydrocarbon. In this embodiment, vapor silane is formed by the MTS exposure and expands significantly. MTS chlorine tabs are hung on MTS when vaporized and mixed with hydrogen chloride acid (HCl). When water vapor is added, ammonium chloride is formed and deposited on bagasse on the line. When setting up the line a nitrogen gas blanket may be used to keep the vaporized MTS gas low in the trommel to prevent escape upwards, and to encourage mixing with the bagasse as it falls. (Nitrogen also provide fire safety.) The mixture is preferably 1:3 of MTS to HCl. HCl reacts with anhydrous ammonia. The ammonia is preferably added to the line upstream (or before) the METS is added. As anhydrous ammonia mixes with eh bagasse (without the presence of vaporized MTS, the HCL and ammonia penetrate into the bagasse and begin to react with the bagasse to prepare the bagasse to receive and mixes with the MTS and allow the final product to form along the outer layers of the bagasse to create a feed source.

A heater may be used to help dry the bagasse before or initially upon entering the line. The temperature ensures that when added, the MTS is quickly vaporized. Heat is also used to ensure the water in the system is vaporized to fill (portions) of the line to allow the water vapor to react. Oxygen in the line is preferably kept to a minimum, preferably less than 5% by volume, and the nitrogen gas inserted is managed to keep the gas levels regular. Sensors 28 on the venting system determine the amount of gas and constituents of the exiting gas to help understand the gas mixture in the line. A vacuum 40 in vent 27 is preferably placed at the end of the line to capture the gases, the gases from the line through the vacuum can then be directed and fed back into the front of the line through gas tube 41. A curtain may be used at the end of the line to allow passage of solid bagasse, while reducing loss of gas from within the line. Flight in the line (tube) is causes by the trommels, and produces a slight air flow in the direction of the line. The resultant nitrogen-rich food additive is deposited on the bagasse, which is then collected off the line. Bagasse may also include corn and other organic plant waste, especially those items high in cellulose.

I claim:

1. A system for the treatment or enhancement of an organic compound by exposure to gaseous material, said system comprising:
a. an organic compound; and
b. a gaseous material exposed to the organic compound.

2. The system of claim 1 wherein the organic compound exposed to the gaseous material comprises bagasse.

3. The system of claim 1 wherein a gaseous material comprises a silane.

4. The system of claim 3 wherein the gaseous material comprises MTS.

5. A method for the treatment or enhancement of an organic compound by exposure to gaseous material, said method comprising the steps of:
a. exposing the organic material to the gaseous material.

6. The method of claim 5 further comprising the step of removing excess moisture from the organic material.

7. The method of claim 5 further comprising the step of increasing nutritional value of the organic material.
